(19) United States
(12) Patent Application Publication
(10) Pub. No.: US 2021/0281979 A1
(43) Pub. Date: Sep. 9, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Shinobu AOTA, Kanagawa (JP)

(73) Assignee: FUJIFILM Business Innovation Corp., Tokyo (JP)

(21) Appl. No.: 16/945,925

(22) Filed: Aug. 2, 2020

(30) Foreign Application Priority Data
Mar. 6, 2020 (JP) 2020-039000

(51) Int. Cl. H04W 4/06; H04W 72/04

(52) U.S. Cl. CPC H04W 4/06; H04W 72/0413; H04W 72/048

(57) ABSTRACT

An information processing apparatus includes a processor. The processor is configured to, when accepting a communication request transmitted from a first terminal apparatus and requesting communication with the information processing apparatus via a communication network and in a case where a second terminal apparatus belonging to a group to which the first terminal apparatus belongs is communicating with the information processing apparatus via the communication network, perform control to communicate with the first terminal apparatus while limiting bandwidth, of the communication network, for the second terminal apparatus so as not to exceed an upper-limit bandwidth of the communication network set in advance for the group.

### CROSS-REFERENCE TO RELATED APPLICATIONS

This application is based on and claims priority under 35 USC 119 from Japanese Patent Application No. 2020-039000 filed Mar. 6, 2020.

### BACKGROUND

### (i) Technical Field

The present disclosure relates to an information processing apparatus and a non-transitory computer readable medium.

### (ii) Related Art

Recently, an information processing system in which bandwidth available to terminal apparatuses is managed by the terminal apparatuses has been proposed (for example, see Japanese Patent No. 6104178).

The information processing system described in Japanese Patent No. 6104178 is configured to manage bandwidth of a subscriber having a plurality of subscriber devices that are connected to a network system.

### SUMMARY

With an information processing system in which a terminal apparatus connected to an information processing apparatus via a communication network is responsible for performing control to avoid a shortage of bandwidth, for example, communication with a specific terminal apparatus may be performed in a concentrated manner temporarily, and a shortage of bandwidth of the communication network might not be suppressed.

Aspects of non-limiting embodiments of the present disclosure relate to providing an information processing apparatus and a non-transitory computer readable medium for enabling communication with a terminal apparatus that makes a new communication request without causing a shortage of bandwidth of a communication network specified in advance for a group into which a plurality of terminal apparatuses are classified.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor. The processor is configured to, when accepting a communication request transmitted from a first terminal apparatus and requesting communication with the information processing apparatus via a communication network and in a case where a second terminal apparatus belonging to a group to which the first terminal apparatus belongs is communicating with the information processing apparatus via the communication network, perform control to communicate with the first terminal apparatus while limiting bandwidth, of the communication network, for the second terminal apparatus so as not to exceed an upper-limit bandwidth of the communication network set in advance for the group.

### BRIEF DESCRIPTION OF THE DRAWINGS

An exemplary embodiment of the present disclosure will be described in detail based on the following figures, wherein:

FIG. 1 is a diagram illustrating an example configuration of an information processing system according to an exemplary embodiment of the present disclosure;

FIG. 2 is a block diagram illustrating an example control system of a management server according to the exemplary embodiment;

FIG. 3 is a diagram illustrating an example of a device information table;

FIG. 4 is a diagram illustrating an example of a bandwidth management information table;

FIG. 5 is a flowchart illustrating an example operation of the management server at the start of communication;

FIG. 6 is a flowchart illustrating an example operation of the management server at the end of communication;

FIG. 7 is a diagram illustrating an example of the bandwidth management information table according to a first example;

FIG. 8 is a diagram illustrating an example configuration of the information processing system according to a second example;

FIG. 9 is a diagram illustrating an example of the device information table according to a third example;

FIG. 10 is a diagram illustrating a configuration of the information processing system according to a modification of the present disclosure;

FIG. 11 is a diagram illustrating the device information table according to the modification;

FIG. 12 is a diagram illustrating the bandwidth management information table according to the modification;

FIG. 13 is a diagram illustrating an example configuration after group formation has been changed in the information processing system illustrated in FIG. 10;

FIG. 14 is a diagram illustrating an example of the device information table for the configuration illustrated in FIG. 13; and

FIG. 15 is a diagram illustrating an example of the bandwidth management information table for the configuration illustrated in FIG. 13.

### DETAILED DESCRIPTION

Hereinafter, an exemplary embodiment of the present disclosure will be described with reference to the drawings. Note that elements having substantially the same functions in the drawings are assigned the same reference numerals, and duplicated descriptions thereof are omitted.

### Exemplary Embodiment

An information processing system 1 according to an exemplary embodiment of the present disclosure is applied to, for example, a network (for example, a local government wide area network (LGWAN)) used in facilities, such as local governments including city offices and town/village offices, for which a certain restriction is imposed on bandwidth. Hereinafter, unless otherwise noted, an example case where the information processing system 1 is applied to an LGWAN is described.

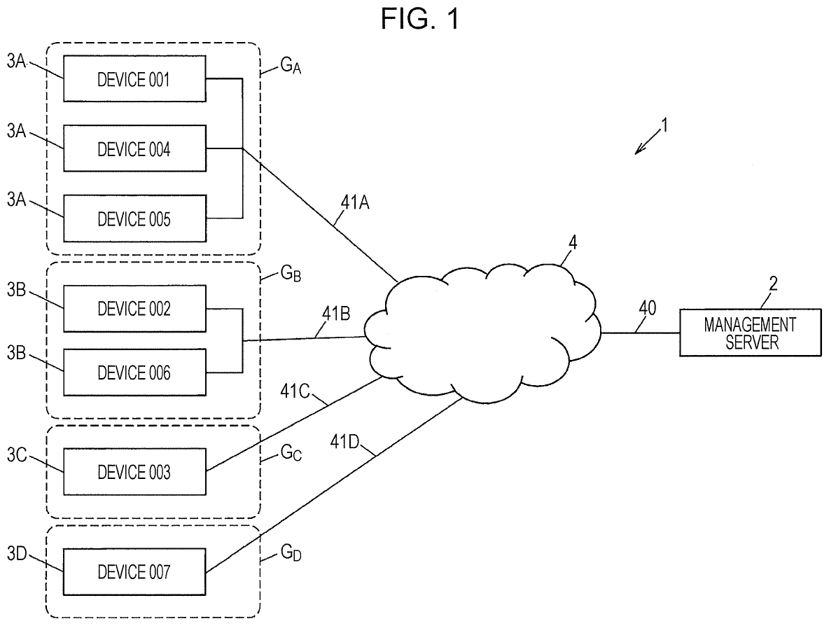

FIG. 1 is a diagram illustrating an example configuration of the information processing system 1. As illustrated in FIG. 1, the information processing system 1 includes a management server 2, a plurality of devices 3A, 3B, 3C, and 3D, and a communication network 4 that connects the management server 2 with the plurality of devices 3A, 3B, 3C, and 3D so as to enable communication. The management server 2 is an example of an information processing apparatus of the present disclosure. The management server 2 will be described in detail below.

The plurality of devices 3A, 3B, 3C, and 3D are managed by the management server 2. The plurality of devices 3A, 3B, 3C, and 3D are classified into groups G_{A}, G_{B}, G_{C}, and G_{D} that are units for each of which the upper limit of its available bandwidth (hereinafter also referred to as “upper-limit bandwidth”) is specified. Although not illustrated, the plurality of devices 3A, 3B, 3C, and 3D are also simply referred to as “device 3” in a case where these devices are generically referred to.

Here, “bandwidth” is the amount of information (in units of, for example, bytes) transmitted per unit time (for example 1 second) to the device 3 that is in communication with the management server 2. A “group” includes one or more of the devices 3A, 3B, 3C, and 3D and is a unit for which bandwidth is managed by the management server 2. For example, “groups” may be groups for classification from the human viewpoint, such as organizations to which the users of the devices 3A, 3B, 3C, and 3D belong or may be groups for classification from the physical viewpoint, such as zones in which the devices 3A, 3B, 3C, and 3D are installed.

“Organizations” are aggregates of people and are, for example, enterprises, companies, businesses, sections (for example, departments, divisions, and teams) belonging thereto, and parties. “Zones” are, for example, districts (for example, public ones, such as municipalities including cities, wards, towns, and villages, and private ones, such as neighborhood associations), buildings, floors, and levels.

An example configuration in which the plurality of devices 3A, 3B, 3C, and 3D are classified into the four groups G_{A}, G_{B}, G_{C}, and G_{D} are described below. The four groups G_{A}, G_{B}, G_{C}, and G_{D} are also respectively referred to as “first group G_{A}”, “second group G_{B}”, “third group G_{C}”, and “fourth group G_{D}” and are also generically referred to as “group G” (not illustrated) in a case where these groups need not be distinguished from each other or identified. The number of groups is not limited to four and may be one, two, three, or five or more. The number of devices 3 belonging to one group G is not limited to a specific number.

Among the plurality of devices 3A, 3B, 3C, and 3D, that belonging to the first group G_{A} is also specifically referred to as “device 3A”, that belonging to the second group G_{B} is also specifically referred to as “device 3B”, that belonging to the third group G_{C} is also specifically referred to as “device 3C”, and that belonging to the fourth group G_{D} is also specifically referred to as “device 3D”.

Examples of the device 3 include an image forming apparatus, such as a multifunction machine, having a plurality of functions including a printer function and a scanner function, a personal computer, and a mobile information terminal, such as a tablet terminal and a multifunction mobile phone (smartphone). The device 3 is an example of a terminal apparatus.

In this exemplary embodiment, the communication network 4 is generally a communication network including a wide area network (WAN). The communication network 4 may be a wired network or a wireless network. The communication network 4 may be a communication network, such as a local area network (LAN), the Internet, or an intranet.

The communication network 4 includes a server-side network 40 for connection with the management server 2, a first device-side network 41A for connection with the device 3A, a second device-side network 41B for connection with the device 3B, a third device-side network 41C for connection with the device 3C, and a fourth device-side network 41D for connection with the device 3D. The first device-side network 41A to the fourth device-side network 41D are also referred to as “device-side network 41” in a case where these networks are generically referred to.

### Configuration of Management Server 2

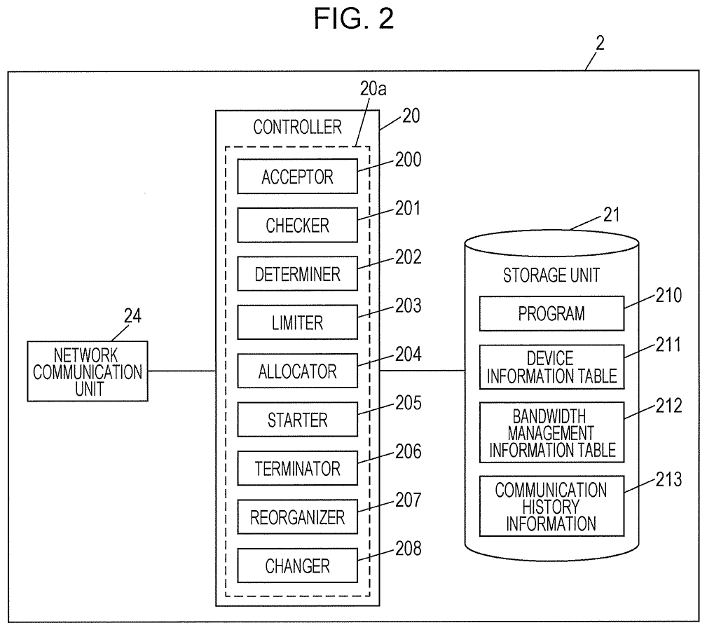

FIG. 2 is a block diagram illustrating an example control system of the management server 2. The management server 2 includes a controller 20 that controls units, a storage unit 21 that stores various types of data, and a network communication unit 24 that communicates with the devices 3 via the communication network 4.

The controller 20 is constituted by a processor 20a, such as a central processing unit (CPU), an interface, etc. The processor 20a operates in accordance with a program 210 stored in the storage unit 21 to function as an acceptor 200, a checker 201, a determiner 202, a limiter 203, an allocator 204, a starter 205, a terminator 206, a reorganizer 207, a changer 208, etc. The acceptor 200, the checker 201, the determiner 202, the limiter 203, the allocator 204, the starter 205, the terminator 206, the reorganizer 207, and the changer 208 will be described in detail below.

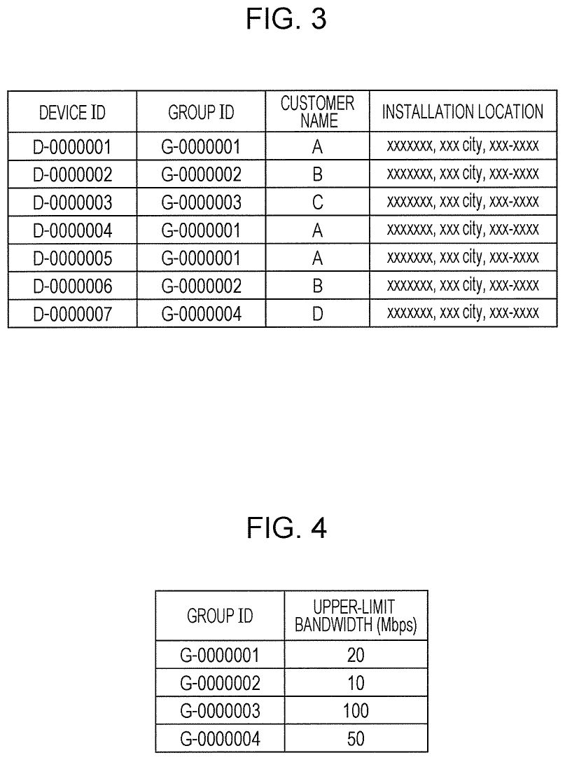

The storage unit 21 is constituted by a read-only memory (ROM), a random access memory (RAM), a hard disk, etc. and stores the program 210 and various types of data including a device information table 211 (see FIG. 3), a bandwidth management information table 212 (see FIG. 4), and communication history information 213. The various types of data will be described in detail below.

The network communication unit 24 is implemented as a network interface card (NIC), etc. and transmits and receives signals to and from the devices 3 via the communication network 4.

### Various Types of Information

FIG. 3 is a diagram illustrating an example of the device information table 211. The device information table 211 is information in which the devices 3 and the groups G to which the devices 3 belong are recorded, and specifically, is information in which the devices 3 and the groups G to which the devices 3 belong are associated with each other and recorded. As illustrated in FIG. 3, in the device information table 211, for example, a “device ID” column, a “group ID” column”, a “customer name” column, and an “installation location” column are provided.

In the “device ID” column, information (hereinafter also referred to as “device IDs”) for identifying all devices 3 managed by the management server 2 is recorded. In the “group ID” column, information (hereinafter also referred to as “group IDs”) for identifying the groups G to which the devices 3 belong is recorded. As the other information, in the “customer name” column, information indicating the names of customers, such as the subscribers using the devices 3, is recorded. In the “installation location” column, information, such as addresses, indicating the locations where the devices 3 are installed is recorded.

Note that FIG. 3 illustrates an example where one group G is set for each customer, that is, an example configuration in which one customer is set as one group G; however, the example is not limited to such a configuration. For example, a configuration may be employed in which a plurality of groups G may be formed for one customer or a plurality of customers form one group G.

The device information table 211 may further include a group name column for recording names given to the groups G, such as the names of companies, enterprises, businesses, departments, parties, or administrators. For example, in a case where the customer names are the same for all devices 3, that is, in a case where all devices 3 belong to the same customer, the group name column may be provided instead of the “customer name” column.

FIG. 3 illustrates an example where addresses are recorded in the “installation location” column; however, the recorded information is not limited to this. For example, information indicating the names of locations where the devices 3 are installed, such as the names of buildings, may be recorded, or information indicating the floors, levels, or regions (that is, “areas”) in the same building may be recorded.

FIG. 4 is a diagram illustrating an example of the bandwidth management information table 212. The bandwidth management information table 212 is information in which an upper-limit bandwidth set in advance for each group G is recorded. As illustrated in FIG. 4, in the bandwidth management information table 212, for example, a “group ID” column and an “upper-limit bandwidth” column are provided.

In the “group ID” column, information corresponding to the group IDs recorded in the device information table 211 described above is recorded. In the “upper-limit bandwidth” column, an upper-limit bandwidth set in advance for each group G is recorded.

An upper-limit bandwidth is the maximum value of bandwidth of the communication network 4 available for use by all devices 3 belonging to the corresponding group G. For example, a specific example case of the group G assigned a group ID “G-0000001” is described. With reference to the device information table 211, the devices 3 belonging to the group G are three devices 3 assigned device IDs “D-0000001”, “D-0000004”, and “D-0000005”.

With reference to the bandwidth management information table 212, the upper-limit bandwidth set in advance for the group G having the group ID “G-0000001” is 20 megabits per second (hereinafter also referred to as “Mbps”). That is, the three devices 3 of “D-0000001”, “D-0000004”, and “D-0000005” are set so that a bandwidth of 20 Mbps is available for use in total at the maximum. In other words, communication of the three devices 3 is controlled so as not to exceed 20 Mbps in total at the maximum.

The sum of the upper-limit bandwidths recorded in the “upper-limit bandwidth” column, that is, the total upper-limit bandwidth of all groups G (hereinafter also referred to as “total bandwidth”), has a constant value and is specified on the basis of, for example, physical restrictions by the communication network 4.

The communication history information 213 is information in which communication histories of the devices 3 managed by the management server 2, that is, histories of the use of bandwidth of the communication network 4 by the devices 3, are recorded. The communication history information 213 includes, for example, device IDs, information indicating the communication capacities of the devices 3 associated with the device IDs, and information indicating the dates and times of communication. The communication history information 213 is an example of attribute information of the devices 3.

### Acceptor 200, Checker 201, Determiner 202, Limiter 203, Allocator 204, Starter 205, Terminator 206, Reorganizer 207, and Changer 208

Now, the acceptor 200, the checker 201, the determiner 202, the limiter 203, the allocator 204, the starter 205, the terminator 206, the reorganizer 207, and the changer 208 that constitute the controller 20 are described. The acceptor 200 accepts various signals and information transmitted from the devices 3. Specifically, the acceptor 200 accepts a communication request transmitted from the device 3 in response to a user operation and requesting communication with the management server 2.

The communication request includes, for example, a device ID and a request for an update of a program, such as firmware, that is, a transmission request for requesting the management server 2 to transmit an update program. The acceptor 200 accepts a communication termination request transmitted from the device 3 in response to a user operation and requesting termination of communication with the management server 2.

The checker 201 checks whether another device 3 belonging to the same group G to which the device 3 transmitting the communication request belongs is connected to the management server 2 via the communication network 4 (hereinafter also referred to as “existing communication”). The device 3 transmitting the communication request is an example of a first terminal apparatus. The other device 3 is an example of a second terminal apparatus.

Specifically, the checker 201 first refers to the device information table 211 and identifies a group ID associated with the device ID included in the communication request accepted by the acceptor 200. Next, the checker 201 identifies another device ID (a device ID other than the device ID included in the communication request) associated with the identified group ID. The checker 201 checks the presence of existing communication by the device 3 having the identified other device ID.

The determiner 202 determines, for example, whether the device 3 that is in existing communication is present in the same group G on the basis of the result of checking by the checker 201.

The limiter 203 limits bandwidth used in existing communication. In this exemplary embodiment, the limiter 203 decreases the bandwidth of each device 3 that is in existing communication to a value (hereinafter also referred to as “decreased amount”) obtained by dividing the upper-limit bandwidth specified for the group G by a number obtained by adding 1 to the number of devices 3 that are in existing communication.

The allocator 204 allocates bandwidth to new communication with the management server 2 by the device 3 transmitting the communication request. Specifically, in a case where the device 3 that is in existing communication is present in the same group G, the allocator 204 allocates an amount of bandwidth decreased by the limiter 203 (that is, the above-described decreased amount) as the bandwidth for new communication.

After one device 3 has terminated communication, the allocator 204 allocates (that is, distributes) bandwidth allocated to the one device 3 terminating communication as the bandwidth of another device 3 that is in existing communication to increase bandwidth used in existing communication. For example, the allocator 204 resets the bandwidth of the device 3 that is in existing communication to a value obtained by dividing the upper-limit bandwidth set in advance for the group G by the number of devices 3 that are in existing communication (that is, the number of devices 3 in existing communication other than the device 3 terminating communication).

In a case where the device 3 that is in existing communication is not present in the same group G, the allocator 204 refers to the bandwidth management information table 212 and allocates the upper-limit bandwidth set in advance for the group G as bandwidth for new communication. That is, in a case where only one device 3 in the group G transmitting the communication request communicates with the management server 2, the allocator 204 performs setting so that the upper-limit bandwidth set in advance for the group G to which the one device 3 belongs is available to the one device 3.

The starter 205 connects the device 3 transmitting the communication request to the management server 2 to start a communication process. The terminator 206 disconnects, in a case where a communication termination request is accepted by the acceptor 200, communication between the device 3 transmitting the communication termination request and the management server 2 to terminate communication.

The reorganizer 207 changes the formation of the groups G (hereinafter also referred to as “reorganization”). Specifically, the reorganizer 207 changes the groups G to which the devices 3 belong to thereby reorganize the groups G. More specifically, the reorganizer 207 changes the group IDs recorded in the device information table 211 to reorganize the groups G. In other words, the reorganizer 207 changes the combinations of the devices 3 that are members of the groups G.

The reorganizer 207 may reorganize the groups G using a predetermined condition. Here, the “predetermined condition” includes, for example, the record of the amount of use of the communication network 4 by each device 3 and the priority of each device 3. For example, the reorganizer 207 may refer to the communication history information 213 to reorganize the groups G from, for example, the viewpoint of avoiding a situation where a specific group G exclusively uses a certain amount of bandwidth or more or the viewpoint of preferentially distributing bandwidth to the group G for which the communication volume is large in accordance with the record of the amount of use, that is, the viewpoint of making the amount of use of bandwidth be balanced among the groups G. The details will be described below (see a second example).

The changer 208 changes the upper-limit bandwidths specified for the groups G. Specifically, the changer 208 changes values recorded in the “upper-limit bandwidth” column of the bandwidth management information table 212. The changer 208 changes the upper-limit bandwidth of each group G so as not to exceed the total bandwidth that is the total upper-limit bandwidth of all groups G. Desirably, the changer 208 changes the upper-limit bandwidth of each group G so that the total bandwidth does not change.

The changer 208 may change the upper-limit bandwidths specified for the groups G using a predetermined condition. Here, the “predetermined condition” includes, for example, the record of the amount of use of the communication network 4 by each group G and the priority of each group G. The changer 208 may refer to the communication history information 213 to change the upper-limit bandwidths from, for example, the viewpoint of avoiding a situation where a specific group G exclusively uses a certain amount of bandwidth or more or the viewpoint of preferentially distributing bandwidth to the group G for which the communication volume is large in accordance with the record of the amount of use, that is, the viewpoint of making the amount of use of bandwidth be balanced among the groups G. The details will be described below (see a first example).

### Operation in Exemplary Embodiment

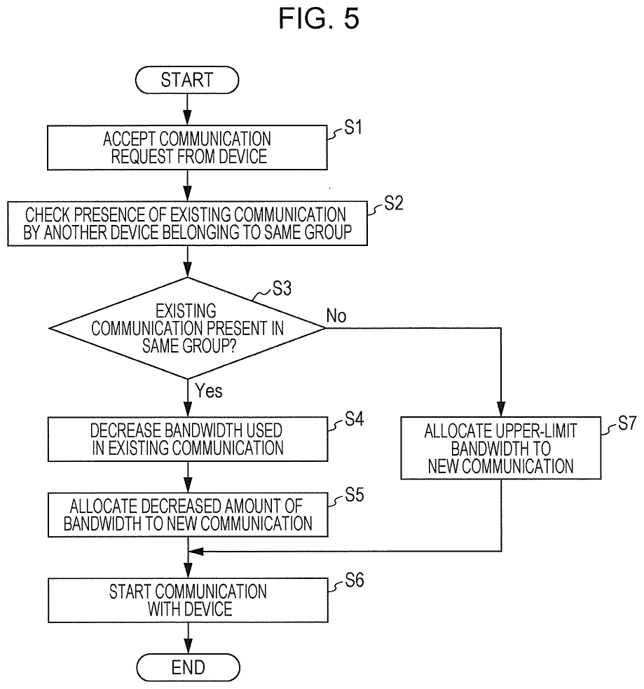

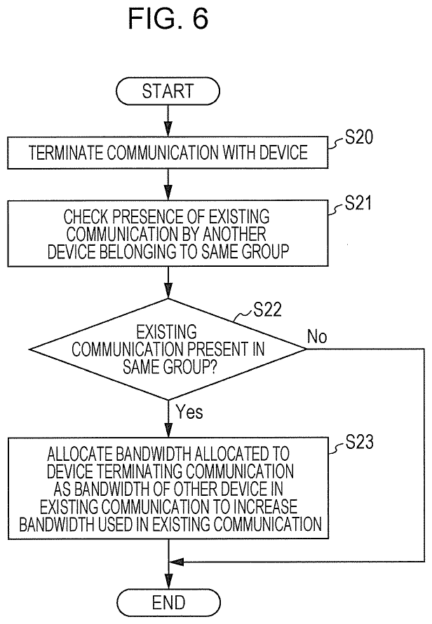

Now, an example operation of the management server 2 is described with reference to FIG. 5 and FIG. 6. The operation of the management server 2 is separated into two operations, namely, (1) an operation at the start of communication and (2) an operation at the end of communication, and described.

### (1) Operation at the Start of Communication

FIG. 5 is a flowchart illustrating an example operation of the management server 2 at the start of communication. First, the acceptor 200 accepts a communication request for new communication transmitted from the device 3 (S1). Next, the checker 201 checks the presence of existing communication by another device 3 belonging to the same group G to which the device 3 belongs (S2).

Next, the determiner 202 determines whether the device 3 that is in existing communication is present in the same group G on the basis of the result of checking by the checker 201 (S3).

In a case where the device 3 that is in existing communication is present in the same group G (Yes in S3), the limiter 203 decreases bandwidth used in existing communication (S4). The allocator 204 allocates the decreased amount of bandwidth to new communication (S5). The starter 205 starts communication with the device 3 (S6).

In a case where the device 3 that is in existing communication is not present in the same group G (No in S3), the allocator 204 refers to the bandwidth management information table 212 to allocate the upper-limit bandwidth specified for the group G to new communication (S7). The starter 205 starts communication with the device 3 (S6).

### (2) Operation at the End of Communication

FIG. 6 is a flowchart illustrating an example operation of the management server 2 at the end of communication. When a communication termination request transmitted from the device 3 is accepted, the terminator 206 terminates communication between the device 3 and the management server 2 (S20).

Next, the checker 201 checks the presence of existing communication by another device 3 belonging to the same group G to which the device 3 belongs (S21). The determiner 202 determines whether the device 3 that is in existing communication is present in the same group G on the basis of the result of checking by the checker 201 (S22).

In a case where the device 3 that is in existing communication is present in the same group G (Yes in S22), the allocator 204 allocates bandwidth allocated to the device 3 terminating communication as the bandwidth of the other device 3 that is in existing communication to increase bandwidth used in existing communication (S23).

### EXAMPLES

Now, examples according to the above-described exemplary embodiment are described. In this exemplary embodiment, the upper-limit bandwidths of the groups G are changed and the formation of the groups G is changed as described above to suppress exclusive use of a certain amount of bandwidth or more by a specific group G or to preferentially allocate bandwidth to the group G for which the communication volume is large, that is, to distribute bandwidth so as to be balanced among the groups G. The following three examples are separately described in detail.
First example: An example where the upper-limit bandwidths of the groups G are changed.
Second example: An example where the formation of the groups G is changed.
Third example: An example where both the upper-limit bandwidths of the groups G and the formation of the groups G are changed.

### (1) First Example

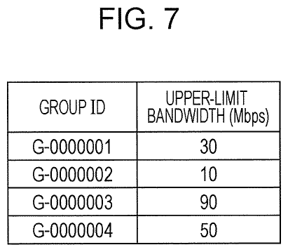

FIG. 7 is a diagram illustrating an example of the bandwidth management information table 212 according to the first example. The changer 208 changes the upper-limit bandwidths specified for the groups G in accordance with an operation by the administrator of the information processing system 1 (for example, an operator of the management server 2). FIG. 7 illustrates the bandwidth management information table 212 in which upper-limit bandwidths changed by the changer 208 are recorded. Example changes in the upper-limit bandwidths are illustrated in Table 1 below.

TABLE 1
Example Changes in Upper-limit Bandwidths

Upper-limit bandwidth (Mbps)

| Group G | Before change | After change |
|---|---|---|
| G-0000001 | 20 | 30 |
| G-0000002 | 10 | 10 |
| G-0000003 | 100 | 90 |
| G-0000004 | 50 | 50 |

Note that as the “before change” information, the values illustrated in FIG. 4 are used.

As illustrated in Table 1, the upper-limit bandwidth of the group G having the group ID “G-0000001” is increased by 10 Mbps and changed from 20 Mbps to 30 Mbps, and the upper-limit bandwidth of the group G having the group ID “G-0000003” is decreased by 10 Mbps and changed from 100 Mbps to 90 Mbps. The upper-limit bandwidth of the group G having the group ID “G-0000002” and that of the group G having the group ID “G-0000004” are not changed. The total upper-limit bandwidth is 180 Mbps before and after change and is not changed before and after change.

As an example application of the above-described example, an example of a company operating in the same building is described. For example, it is assumed that the groups G are set for the respective levels. Specifically, it is assumed that all devices 3 installed at the N-th level belong to the group “G-0000001” and all devices 3 installed at the M-th level belong to the group “G-0000003”. For example, in a case where the bandwidth of the group G of “G-0000001” at the N-th level tends to run short and the bandwidth of the group G of “G-0000003” at the M-th level tends to be excessive, part of the upper-limit bandwidth of the group “G-0000003” (for example, 10 Mbps) may be allotted as the upper-limit bandwidth of the group “G-0000001” as illustrated in Table 1.

### (2) Second Example

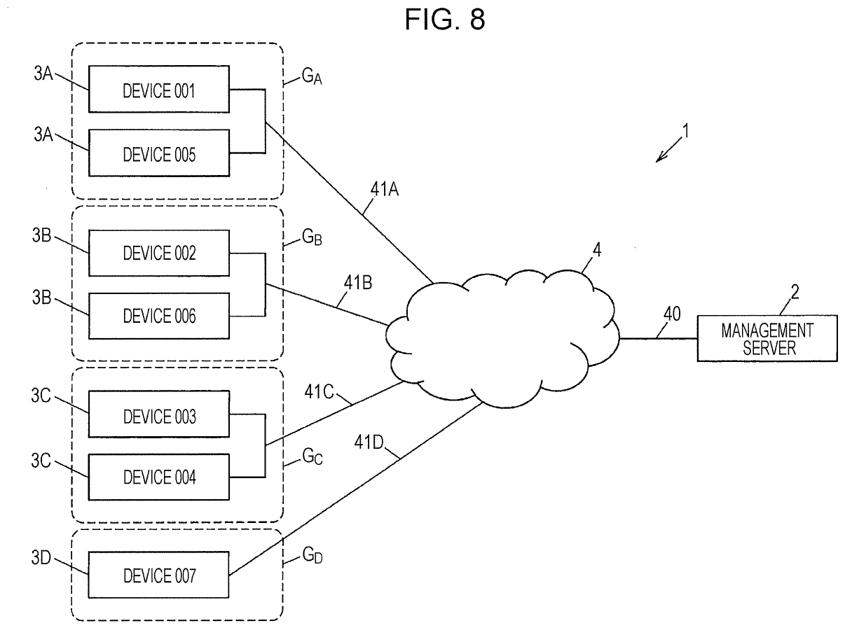

FIG. 8 is a diagram illustrating an example configuration of the information processing system 1 according to the second example. The reorganizer 207 reorganizes the groups G in accordance with an operation by the administrator of the information processing system 1. FIG. 8 illustrates a configuration of the information processing system 1 after reorganization by the reorganizer 207. Example reorganization of the groups G is illustrated in Table 2 below.

TABLE 2
Example Reorganization of Groups G

| | |
|---|---|
| Upper-limit | |
| bandwidth | Devices forming group G |

| Group G | (Mbps) | Before change | After change |
|---|---|---|---|
| G-0000001 | 20 | D-0000001 | D-0000001 |
| | | D-0000004 | |
| | | D-0000005 | D-0000005 |
| G-0000002 | 10 | D-0000002 | D-0000002 |
| | | D-0000006 | D-0000006 |
| G-0000003 | 100 | D-0000003 | D-0000003 |
| | | | D-0000004 |
| G-0000004 | 50 | D-0000007 | D-0000007 |

Note that as the “before change” information, the configuration illustrated in FIG. 1 and the values illustrated in FIG. 3 are used.

An example the same as the above-described example is used to give a description. For example, in the case where the bandwidth of the group G of “G-0000001” installed at the N-th level tends to run short and the bandwidth of the group G of “G-0000003” installed at the M-th level tends to be excessive, the groups G may be reorganized such that a number of devices 3 belonging to the group “G-0000001” may be removed from the group “G-0000001” so as to belong to the group “G-0000003”.

Accordingly, the number of devices 3 belonging to the group G having the group ID “G-0000001” may be decreased from three to two, and the number of devices 3 belonging to the group G having the group ID “G-0000003” may be increased from one to two. Consequently, a shortage of the bandwidth of the group G having the group ID “G-0000001” may be suppressed while excessive bandwidth of the group G having the group ID “G-0000003” may be effectively used. That is, bandwidth may be kept balanced among the groups G without changing the upper-limit bandwidths.

Note that it may be determined which of the devices 3 in the group G is to be moved to another group G with reference to, for example, the communication history information 213. The groups G may be reorganized by changing the records in the device information table 211, and the installation locations of the devices 3 need not be physically moved. As in the example illustrated in Table 2, setting may be performed so that the devices 3 installed at different levels belong to the same group G. That is, the group G may be set across different levels.

### (3) Third Example

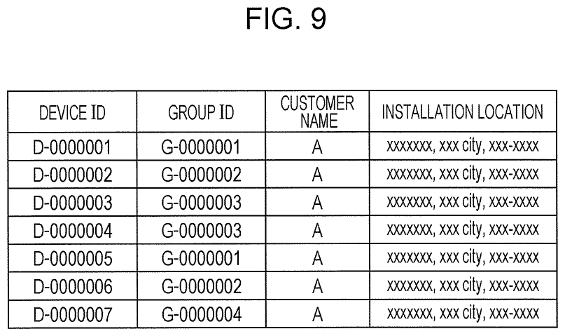

FIG. 9 is a diagram illustrating an example of the device information table 211 according to the third example. The first example and the second example described above may be combined. That is, in accordance with an operation by the administrator of the information processing system 1, the changer 208 may change the upper-limit bandwidths specified for the groups G, and the reorganizer 207 may reorganize the groups G. An example where both the upper-limit bandwidths of the groups G and the formation of the groups G are changed is illustrated in Table 3 below.

TABLE 3
Example Changes in Upper-limit Bandwidths
and Formation of Groups G

| | Upper-limit bandwidth | | | |
|---|---|---|---|---|
| | (Mbps) | | Devices forming group G | |
| | Before | After | Before | After |
| Group G | change | change | change | change |
| G-0000001 | 20 | 30 | D-0000001 | D-0000001 |
| | | | D-0000004 | |
| | | | D-0000005 | D-0000005 |
| G-0000002 | 10 | 10 | D-0000002 | D-0000002 |
| | | | D-0000006 | D-0000006 |
| G-0000003 | 100 | 90 | D-0000003 | D-0000003 |
| | | | | D-0000004 |
| G-0000004 | 50 | 50 | D-0000007 | D-0000007 |

Note that as the “before change” information, the configuration illustrated in FIG. 1 and the values illustrated in FIG. 3 and FIG. 4 are used.

### Modifications

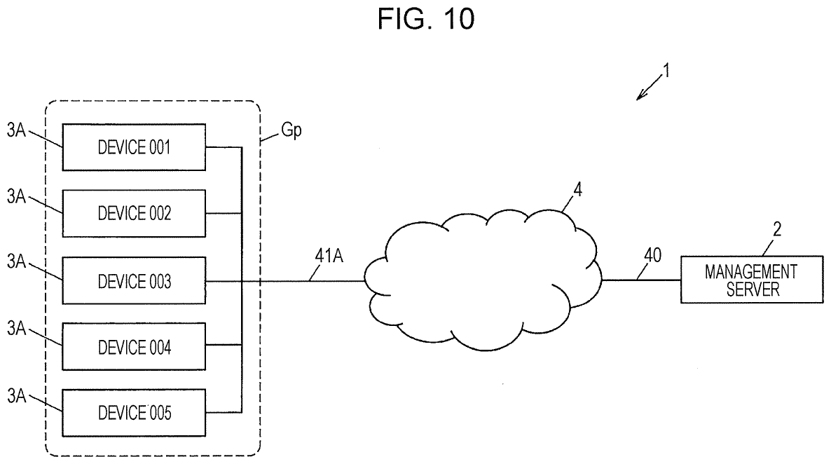

The group G may have a plurality of layers. As modifications, an example where the group G is configured to have two layers, namely, an upper-layer group G and a lower-layer group G positioned below the upper-layer group G, is described with reference to FIG. 10 to FIG. 15. Note that an element having the same configuration and function as in the above-described exemplary embodiment is assigned the same reference numeral, and a detailed description thereof is omitted. Differences from the above-described exemplary embodiment are focused and described.

In the group G having two layers, the upper-layer group is also referred to as “parent group Gp” and the lower-layer group is also referred to as “child group Gc”. The parent group Gp is an example of an upper-layer group. The child group Gc is an example of a lower-layer group. The number of layers in the group G is not limited to two, and may be three (in this case, the groups are also referred to as a parent group, a child group, and a grandchild group) or four or more.

### Modification 1-1

FIG. 10 is a diagram illustrating a configuration of the information processing system 1 according to a modification of the present disclosure. As illustrated in FIG. 10, in the information processing system 1, five devices 3, namely, “device 001” to “device 005”, are provided, and the five devices 3 are classified into one parent group Gp.

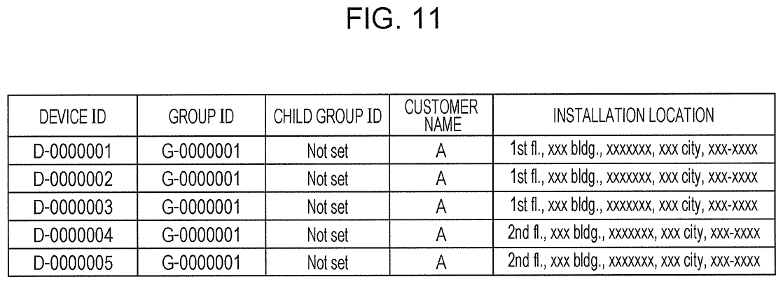

FIG. 11 is a diagram illustrating the device information table 211 according to this modification. As illustrated in FIG. 11, in the device information table 211, a “child group ID” column is further provided.

The device IDs (specifically, “D-0000001” to “D-0000005”) of the above-described five devices 3 are associated with the same group ID (specifically, “G-0000001”) so as to match with the configuration illustrated in FIG. 10. In the “child group ID” column, “not set” is recorded.

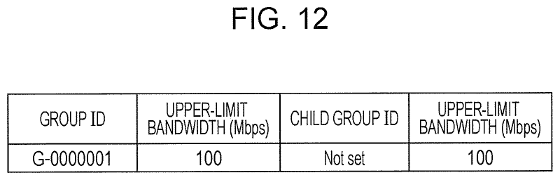

FIG. 12 is a diagram illustrating the bandwidth management information table 212 according to this modification. As illustrated in FIG. 12, in the bandwidth management information table 212, a “child group ID” column and an “upper-limit bandwidth” column in which an upper-limit bandwidth specified for the child group Gc is recorded are further provided. For example, for the parent group Gp of “G-0000001”, an upper-limit bandwidth of 100 Mbps is set. In the “child group ID” column of the child group Gc, “not set” is recorded.

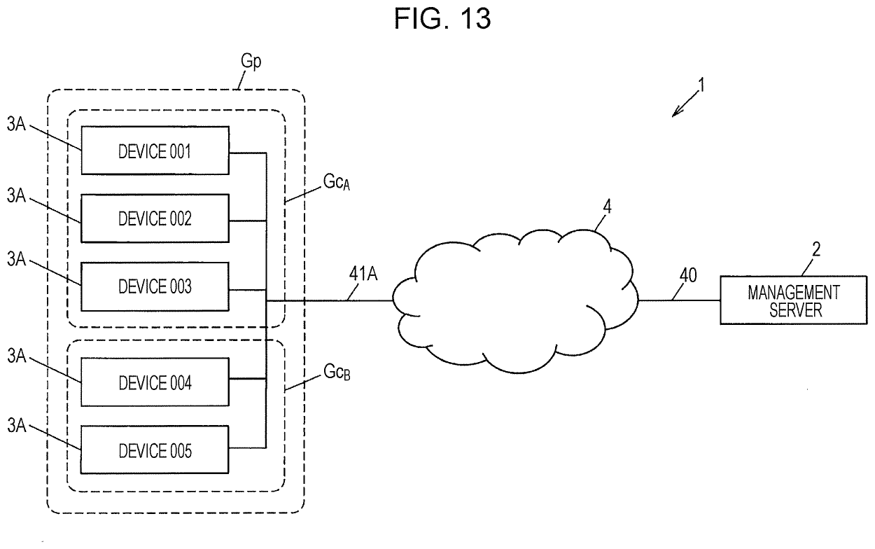

FIG. 13 is a diagram illustrating an example configuration after group formation has been changed in the information processing system illustrated in FIG. 10. An example case where the parent group Gp is divided into two child groups Gc as illustrated in FIG. 13 is described. For convenience of description, one of the two child groups Gc is also referred to as “first child group Gc_{A}” and the other is also referred to as “second child group Gc_{B}”.

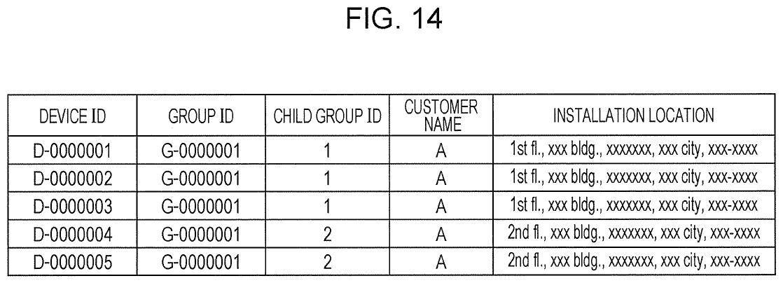

FIG. 14 is a diagram illustrating an example of the device information table 211 for the configuration illustrated in FIG. 13. As illustrated in FIG. 14, in the “child group ID” column, identification information for identifying the child groups Gc (here, single-digit natural numbers) is recorded so as to match with the configuration illustrated in FIG. 13.

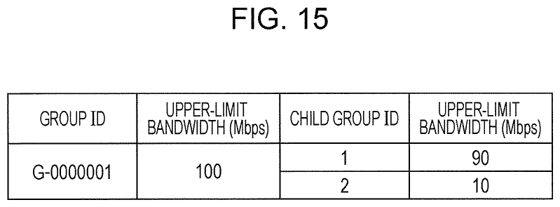

FIG. 15 is a diagram illustrating an example of the bandwidth management information table 212 for the configuration illustrated in FIG. 13. As illustrated in FIG. 15, of 100 Mbps set in advance for the parent group Gp, 90 Mbps is allotted to the first child group Gc_{A} and 10 Mbps is allotted to the second child group Gc_{B}.

That is, in the above-described example, the five devices 3 are classified into the same parent group Gp and the upper-limit bandwidth of the parent group Gp is set to 100 Mbps initially. It is assumed here that in a case where more than one of the devices 3 simultaneously communicate, bandwidth available to each device 3 is limited to a value obtained by dividing the upper-limit bandwidth by the number of communicating devices 3. Then, in a case where all of the five devices 3 simultaneously communicate in the above-described example, bandwidth available to each device 3 is, for example, limited to 20 Mbps.

On the other hand, in a case where the five devices 3 are simultaneously communicating and where, for example, it is found that 20 Mbps is not sufficient for three devices 3, namely, “device 001” to “device 003”, among the five devices 3 because of, for example, the high priority of their tasks and that this causes a delay in processing and hinders the performance of the tasks, the child groups Gc may be provided and an upper limit may be set for each child group Gc.

When 90 Mbps is thus allocated to the three devices 3, namely, “device 001” to “device 003”, even in a case where the five devices 3 simultaneously communicate, a bandwidth of 30 Mbps is maintained for each of the three devices 3, namely, “device 001” to “device 003”.

The sum of the upper-limit bandwidth of the first child group Gc_{A} and the upper-limit bandwidth of the second child group Gc_{B} after allotment is 100 Mbps, which is the same as the upper-limit bandwidth set in advance for the parent group Gp. That is, the first child group Gc_{A} and the second child group Gc_{B} are set by changing the distribution of the upper-limit bandwidth without changing the upper-limit bandwidth set in advance for the parent group Gp.

### Modification 1-2-1

The reorganizer 207 may further reorganize the child groups Gc. For example, the reorganizer 207 may change the child group Gc to which the device 3 of “D-0000001” belongs from the first child group Gc_{A} to the second child group Gc_{B} in the example illustrated in FIG. 14. Specifically, the reorganizer 207 may change “1” recorded in the “child group ID” column for the device 3 of “D-0000001” to “2” in the device information table 211 to thereby change the child group Gc from the first child group Gc_{A} to the second child group Gc_{B}.

### Modification 1-2-2

As another example, the reorganizer 207 may generate a new child group Gc and classify the device 3 into the newly generated child group Gc. Specifically, the reorganizer 207 may change “2” recorded in the “child group ID” column for the device 3 of “D-0000005” to “3” to thereby generate a third child group Gc_{c} and classify the device 3 of “D-0000005” into the third child group Gc_{c}.

### Modification 2

After the end of communication, the result of execution may be checked. In a case where an error caused by narrow bandwidth is determined, control may be performed to, for example, reconsider the upper-limit bandwidths of the child groups.

The exemplary embodiment of the present disclosure has been described above; however, exemplary embodiments of the present disclosure are not limited to the above-described exemplary embodiment, and various modifications and implementations can be made without departing from the spirit of the present disclosure.

Some or all of the acceptor 200, the checker 201, the determiner 202, the limiter 203, the allocator 204, the starter 205, the terminator 206, the reorganizer 207, and the changer 208 of the controller 20 may be implemented as a hardware circuit, such as a field-programmable gate array (FPGA) or an application-specific integrated circuit (ASIC).

Further, some of the elements in the above-described exemplary embodiment may be omitted or changed. Any step may be, for example, added to, deleted from, changed, or replaced in the flows of the above-described exemplary embodiment without departing from the spirit of the present disclosure. The program used in the above-described exemplary embodiment may be recorded to a computer-readable recording medium, such as a compact disc read-only memory (CD-ROM) and provided, or may be stored on an eternal server, such as a cloud server, and used via a network.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
when accepting a communication request transmitted from a first terminal apparatus and requesting communication with the information processing apparatus via a communication network and in a case where a second terminal apparatus belonging to a group to which the first terminal apparatus belongs is communicating with the information processing apparatus via the communication network, perform control to communicate with the first terminal apparatus while limiting bandwidth, of the communication network, for the second terminal apparatus so as not to exceed an upper-limit bandwidth of the communication network set in advance for the group.

2. The information processing apparatus according to claim 1, wherein
the processor is configured to set the group in accordance with history information indicating a history of use of bandwidth of the communication network by the first terminal apparatus and the second terminal apparatus.

3. The information processing apparatus according to claim 2, wherein
the processor is configured to further set lower-layer groups using a predetermined condition below an upper-layer group set in advance.

4. The information processing apparatus according to claim 3, wherein
the processor is configured to set the lower-layer groups by changing distribution of the upper-limit bandwidth in the upper-layer group without changing the upper-limit bandwidth that is set in advance for the upper-layer group.

5. The information processing apparatus according to claim 1, wherein
the processor is configured to change a combination of terminal apparatuses forming the group without changing the upper-limit bandwidth set in advance for the group.

6. The information processing apparatus according to claim 2, wherein
the processor is configured to change a combination of terminal apparatuses forming the group without changing the upper-limit bandwidth set in advance for the group.

7. The information processing apparatus according to claim 3, wherein
the processor is configured to change a combination of terminal apparatuses forming the group without changing the upper-limit bandwidth set in advance for the group.

8. The information processing apparatus according to claim 4, wherein
the processor is configured to change a combination of terminal apparatuses forming the group without changing the upper-limit bandwidth set in advance for the group.

9. The information processing apparatus according to claim 1, wherein
the processor is configured to set the upper-limit bandwidth such that attribute information indicating an attribute of the first terminal apparatus and an attribute of the second terminal apparatus satisfies a predetermined condition.

10. The information processing apparatus according to claim 2, wherein
the processor is configured to set the upper-limit bandwidth such that attribute information indicating an attribute of the first terminal apparatus and an attribute of the second terminal apparatus satisfies a predetermined condition.

11. The information processing apparatus according to claim 3, wherein
the processor is configured to set the upper-limit bandwidth such that attribute information indicating an attribute of the first terminal apparatus and an attribute of the second terminal apparatus satisfies a predetermined condition.

12. The information processing apparatus according to claim 4, wherein
the processor is configured to set the upper-limit bandwidth such that attribute information indicating an attribute of the first terminal apparatus and an attribute of the second terminal apparatus satisfies a predetermined condition.

13. The information processing apparatus according to claim 5, wherein
the processor is configured to set the upper-limit bandwidth such that attribute information indicating an attribute of the first terminal apparatus and an attribute of the second terminal apparatus satisfies a predetermined condition.

14. The information processing apparatus according to claim 6, wherein
the processor is configured to set the upper-limit bandwidth such that attribute information indicating an attribute of the first terminal apparatus and an attribute of the second terminal apparatus satisfies a predetermined condition.

15. The information processing apparatus according to claim 7, wherein
the processor is configured to set the upper-limit bandwidth such that attribute information indicating an attribute of the first terminal apparatus and an attribute of the second terminal apparatus satisfies a predetermined condition.

16. The information processing apparatus according to claim 8, wherein
the processor is configured to set the upper-limit bandwidth such that attribute information indicating an attribute of the first terminal apparatus and an attribute of the second terminal apparatus satisfies a predetermined condition.

17. The information processing apparatus according to claim 9, wherein
the processor is configured to set the upper-limit bandwidth in accordance with history information indicating a history of use of bandwidth of the communication network by the first terminal apparatus and the second terminal apparatus, the history information being the attribute information.

18. The information processing apparatus according to claim 10, wherein
the processor is configured to set the upper-limit bandwidth in accordance with the history information indicating the history of use of the bandwidth of the communication network by the first terminal apparatus and the second terminal apparatus, the history information being the attribute information.

19. The information processing apparatus according to claim 11, wherein
the processor is configured to set the upper-limit bandwidth in accordance with the history information indicating the history of use of the bandwidth of the communication network by the first terminal apparatus and the second terminal apparatus, the history information being the attribute information.

20. A non-transitory computer readable medium storing a program causing a computer to execute a process for information processing, the process comprising
when accepting a communication request transmitted from a first terminal apparatus and requesting communication with an information processing apparatus via a communication network and in a case where a second terminal apparatus belonging to a group to which the first terminal apparatus belongs is communicating with the information processing apparatus via the communication network, performing control to communicate with the first terminal apparatus while limiting bandwidth, of the communication network, for the second terminal apparatus so as not to exceed an upper-limit bandwidth of the communication network set in advance for the group.
